(19) United States
(12) Patent Application Publication
(10) Pub. No.: US 2011/0010854 A1
(43) Pub. Date: Jan. 20, 2011

(54) SIDERAIL WITH STORAGE AREA

(76) Inventors: Robert M. Zerhusen, Cincinnati, OH (US); Charles A. Howell, Batesville, IN (US); Michelle L. Kovach, Batesville, IN (US); Timothy A. Stanley, Indianapolis, IN (US)

Correspondence Address: HILL-ROM SERVICES, INC., Legal Dept., Mail Code K04, 1069 State Road 46 East, BATESVILLE, IN, 47006, US

(21) Appl. No.: 12/589,536

(22) Filed: Jul. 15, 2009

(51) Int. Cl. A47C 21/08; B23P 6/00

(52) U.S. Cl. 5/425; 29/402.01

(57) ABSTRACT

A person-support apparatus can include a frame and a siderail. The frame is configured to support a person thereon. The siderail is coupled to the frame. The siderail includes a first surface and a second surface. The first surface is oriented such that the first surface faces towards a person supported on the person-support apparatus and the second surface is oriented such that the second surface faces away from the person supported on the person-support apparatus. At least one of the first surface and the second surface has a recessed portion that defines a storage area configured to receive and removably retain one or more objects therewithin.

### BACKGROUND OF THE DISCLOSURE

This disclosure relates generally to person-support apparatuses. More particularly, but not exclusively, one illustrative embodiment relates to a person-support apparatus including a siderail with an integrated storage area.

People staying in hospitals can often bring personal belongings with them. The belongings can be collected by caregivers and stored until the person is discharged or the person requests an item. The belongings can be stored in a storage room that can include lockers, storage bins, drawers, and/or bags with identifying information, such as, the patient's room number, listed thereon, and/or a list of the items and/or bin, locker, or bag numbers and/or location put on the patient's medical chart. The people can also be provided with storage space for storing personal belongings or other objects in the hospital room in various shelving units or other furniture storage areas, such as, drawers and/or closets. While various person-support apparatuses have been developed, there is still room for development. Thus a need persists for further contributions in this area of technology.

### SUMMARY OF THE DISCLOSURE

The present disclosure includes one or more of the features recited in the appended claims and/or the following features which, alone or in any combination, may comprise patentable subject matter.

One illustrative embodiment of the present disclosure can include a siderail with an indented portion that defines a storage area to place objects within. Another illustrative embodiment can include a siderail with an indented portion that defines a storage area to place objects within and a retaining element to maintain the objects in the storage area.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective view of a person-support apparatus with siderails coupled to a frame of the person-support apparatus according to an embodiment of the current disclosure;

FIG. 2 is a perspective view of a person-support apparatus with siderails coupled to a frame of the person-support apparatus according to another embodiment of the current disclosure;

FIG. 3 is a perspective side view of a head siderail of FIG. 1, including a storage area on a first surface of a head siderail according to an embodiment of the current disclosure;

FIG. 4 is a perspective side view of a head siderail of FIG. 1, including a storage area on a second surface of the head siderail according to an embodiment of the current disclosure;

FIG. 5 is a perspective side view of a foot siderail of FIG. 1, including a storage area according to an embodiment of the current disclosure;

FIG. 6 is a perspective side view of the siderail of FIG. 1, including a storage area according to an embodiment of the current disclosure;

FIG. 7 is a perspective side view of the siderail of FIG. 1, including a storage area according to another embodiment of the current disclosure;

FIG. 8 is a perspective side view of the siderail of FIG. 1, including a storage area according to yet another embodiment of the current disclosure

FIG. 9 is a perspective side view of the siderail of FIG. 1, including a storage area according to yet another embodiment of the current disclosure; and

FIG. 10 is a perspective side view of the siderail of FIG. 1, including a removable module according to one embodiment of the current disclosure.

FIG. 11 is a perspective side view of the siderail of FIG. 9, including a removable module according to another embodiment of the current disclosure.

FIG. 12 is a perspective side view of the siderail of FIG. 9, including a removable module according to yet another embodiment of the current disclosure.

FIG. 13 is a perspective front view of the removable module of FIG. 9, configured to be a storage area according to one embodiment of the current disclosure.

FIG. 14 is a perspective front view of the removable module of FIG. 9, configured to be a fabric dispenser according to one embodiment of the current disclosure.

FIG. 15 is a perspective side view of the removable module of FIG. 9, showing the retainer and engagement surface.

FIG. 16 is a perspective bottom view of the removable module of FIG. 9, showing the retainer and engagement surface.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment of the present disclosure can include a siderail with an indented portion that defines a storage area to place objects within. Another illustrative embodiment can include a siderail with an indented portion that defines a storage area to place objects within and a retaining element to maintain the objects in the storage area.

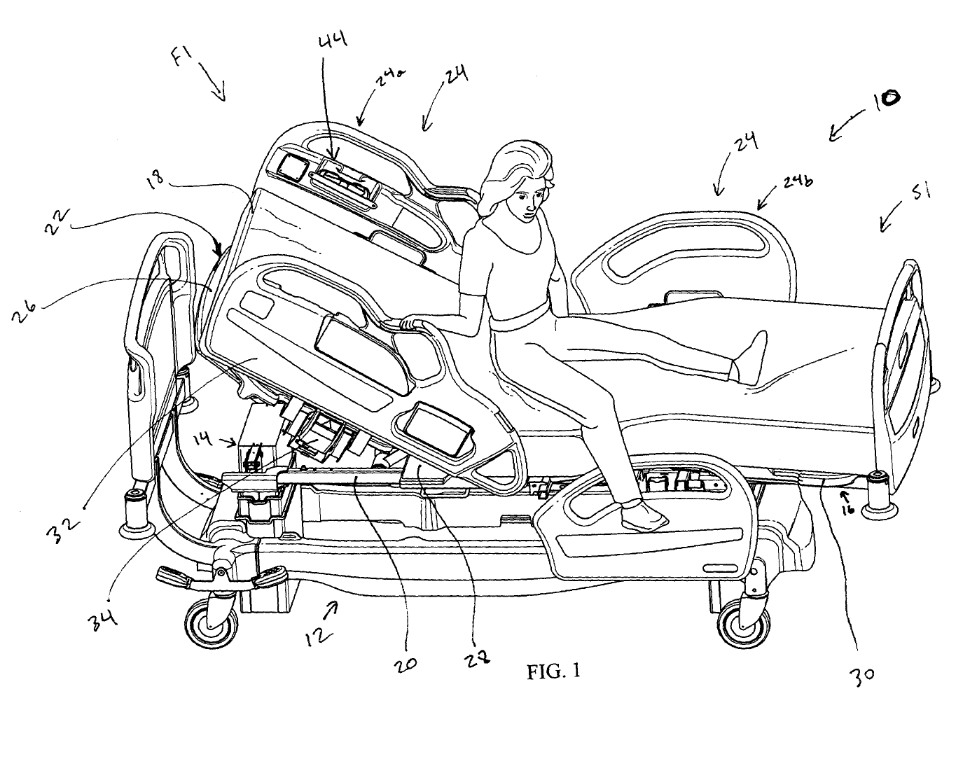

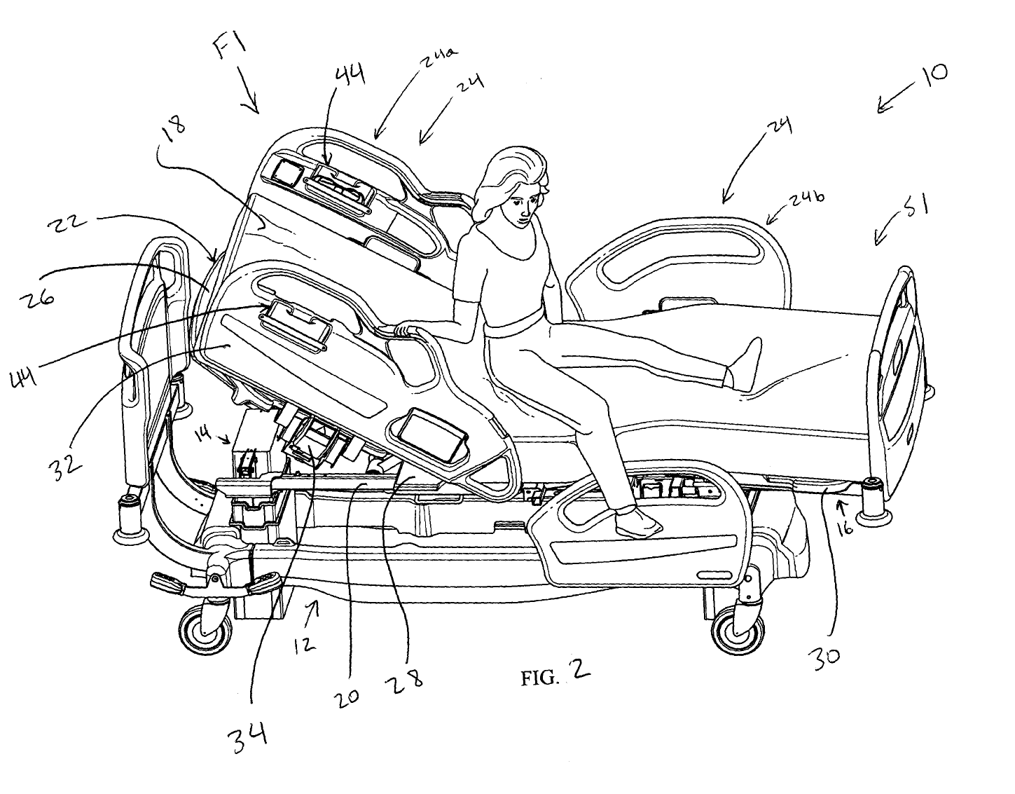

A person-support apparatus 10 according to one illustrative embodiment of the current disclosure is shown in FIGS. 1 and 2. The person-support apparatus 10 can have a first section F1 or head support section F1, where the head of a person can be positioned and a second section S1 or a foot support section S1, where the feet of the person can be positioned. It should be appreciated that the first section F1 and the second section S1 can be portions of the same section. In one illustrative embodiment, the person-support apparatus 10 can be a hospital bed. It should be appreciated that the person-support apparatus 10 can also be a hospital stretcher or an operating table. The person-support apparatus 10 can include a lower frame 12 or base 12, a plurality of supports 14 coupled with the lower frame 12, and an upper frame 16 supported on the supports 14 above the lower frame 12. It should be appreciated that the supports 14 can be lift mechanisms 14 that can move the upper frame 16 with respect to the lower frame 12. It should also be appreciated that in one illustrative embodiment the person-support apparatus 10 can support a person-support surface 18 thereon.

The upper frame 16 can include an intermediate frame 20, a deck 22, and siderails 24 as shown in FIGS. 1 and 2. The intermediate frame 20 can be coupled with the supports 14 and can support the deck 22 thereon as shown in FIGS. 1 and 2. The deck 22 can include a head portion 26, a seat portion 28, and a foot portion 30. The head portion 26, the seat portion 28, and the foot portion 30 can be movably coupled with each other and the intermediate frame 20.

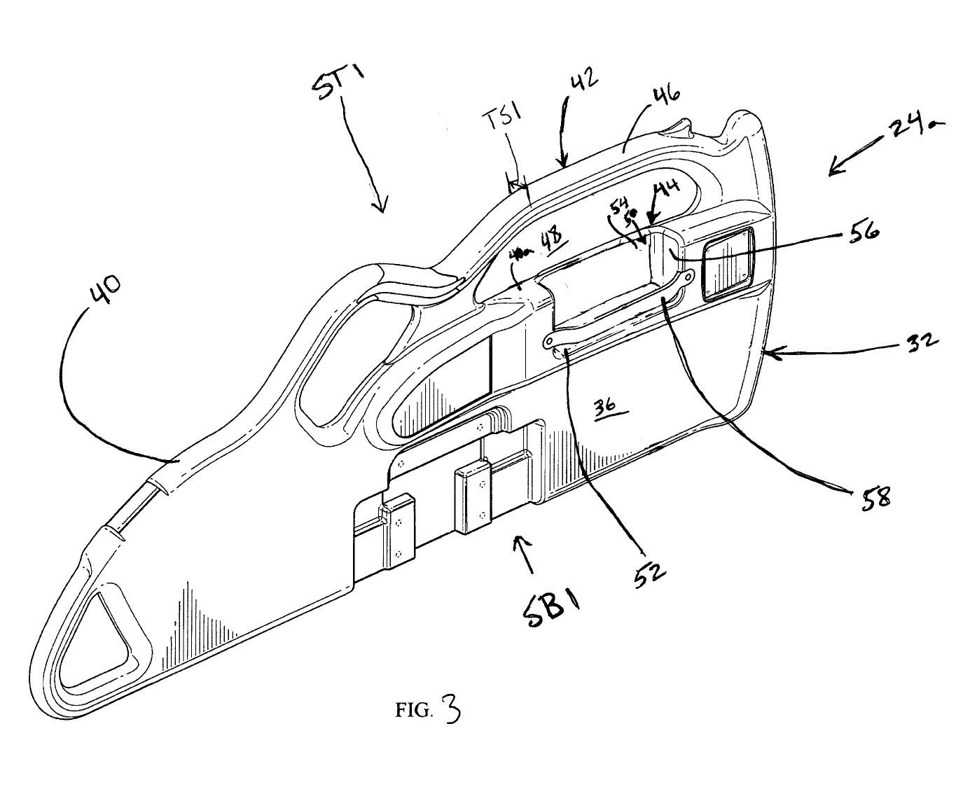

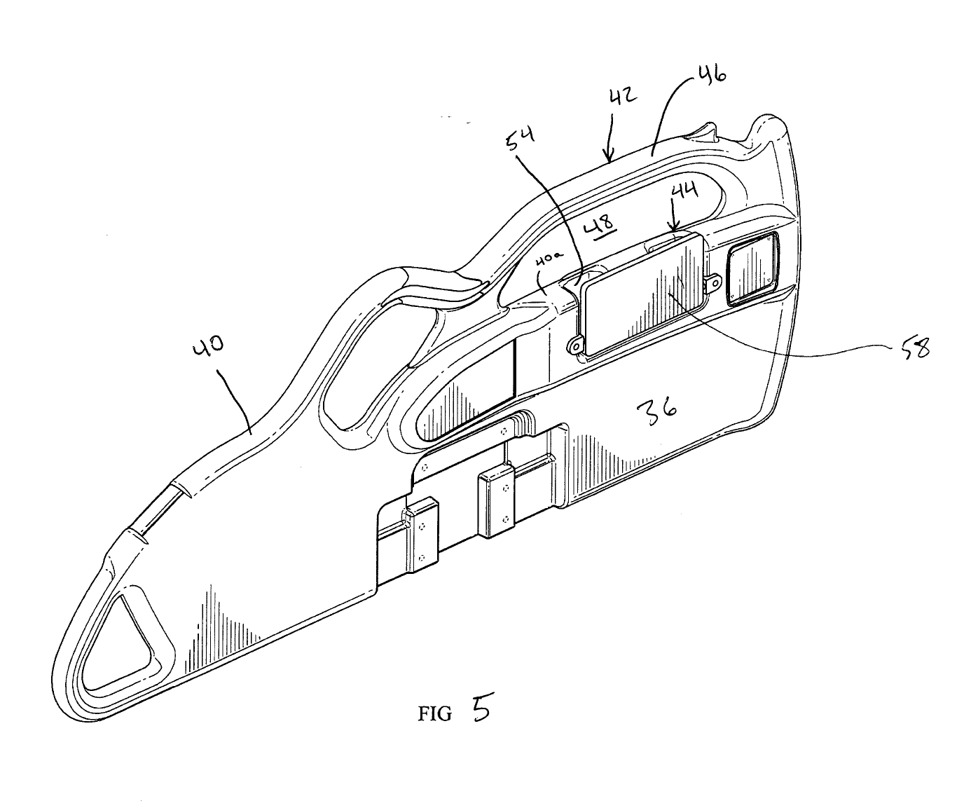

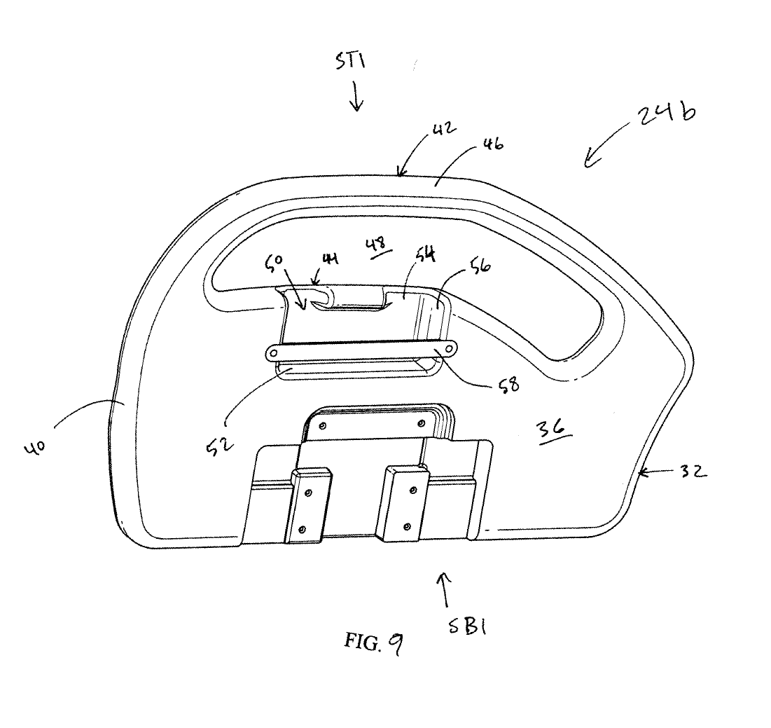

The siderails 24 can include a siderail body 32 with a top portion ST1 and a bottom portion SB1, and a siderail linkage 34 as shown in FIGS. 1-9. In one illustrative embodiment, the siderails 24 can have a thickness TS1 of less than 3 inches. It should be appreciated that the siderails 24 can have a thickness TS1 of between about 1.5 inches and about 2 inches. The siderail linkage 34 can be coupled to the bottom portion SB1 of the siderail body 32 and can couple the siderails 24 to the deck 22 and/or the intermediate frame 20. In one illustrative embodiment, the siderails 24 can be coupled to the head portion 26 of the deck 22 (i.e., a first siderail 24a or a head siderail 24a) and/or coupled to the foot portion 30 of the deck 22 and/or the intermediate frame 20 (i.e., a second siderail 24b or a foot siderail 24b) as shown in FIG. 1. The siderail linkage 34 can be configured to can facilitate movement of the siderails 24 between a deployed/operation position and a storage position. In the deployed/operation position, as shown in FIG. 1, the siderails 24 can be present above the upper frame 16. In the storage position, the siderails 24 can be moved to a lower position below the upper frame 16. It should be appreciated that the siderail linkage 34 can include a locking mechanism (not shown) that can maintain the siderails 24 in one of the operating and/or storage position when locked and can facilitate movement of the siderails 24 between the operating and storage position when unlocked.

The siderail body 32 can include a first surface 36, a second surface 38, a side surface 40 extending between the first surface 36 and the second surface 38, a grip portion 42, and an indented portion 44 as shown in FIGS. 1-9. It should be appreciated that the siderail 24 can include a caregiver interface (not shown) that can be operable to control various functionalities of the person-support apparatus 10. The first surface 36 and the second surface 38 can be substantially parallel to one another. The first surface 36 can be oriented such that the first surface 36 faces towards a person supported on the person-support surface 18 and the second surface 38 can be oriented such that the second surface 38 faces away from the person supported on the person-support apparatus 10.

The grip portion 42 can be configured to be gripped by a person supported on the person-support apparatus 10 to assist the person with ingress/egress from the person support apparatus 10. In one illustrative embodiment, the grip portion 42 can be located along the top portion ST1 and can include a grip 46 and a grip opening 48 that can pass through the siderail body 32 and be configured to allow a person to wrap their fingers/hand around the grip 46 as shown in FIGS. 1-9. It should be appreciated that the grip portion 32 can include a grip opening cover (not shown) or net (not shown) that can be positioned within the grip opening 48 so that a person can partially wrap their fingers around the grip 46. In one illustrative embodiment, an upper portion of the grip opening 48 can define the bottom of the grip 46 and a lower portion of the grip opening 48 opposite the upper portion of the grip opening 48 can define a portion of the upper side surface 40a.

The indented portion 44 can define a storage area 50 for holding one or more objects as shown in FIGS. 1-9. The storage area 50 can allow a person supported on the person-support apparatus 10 to store personal belongings PB1 within reach, which can reduce the time spent by the caregiver in fetching the personal belongings PB1 of the person. The one or more personal belongings PB1 can be or can include at least one of an eye glass, a piece of jewelry, dentures, photos, magazines, tissues, toiletries and any other personal effects or belongings. It should be appreciated that the storage area 50 can be used by a caregiver to store various objects or devices (not shown) used for diagnosis purposes, infection control (i.e., sanitizing wipes or liquid), or other items.

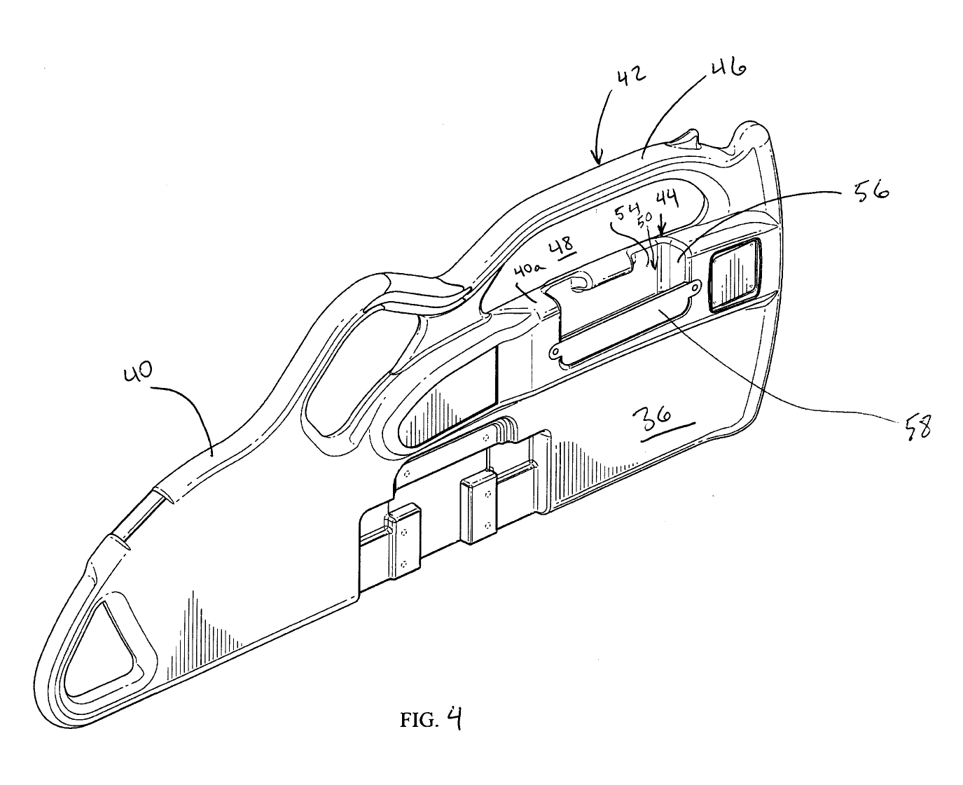

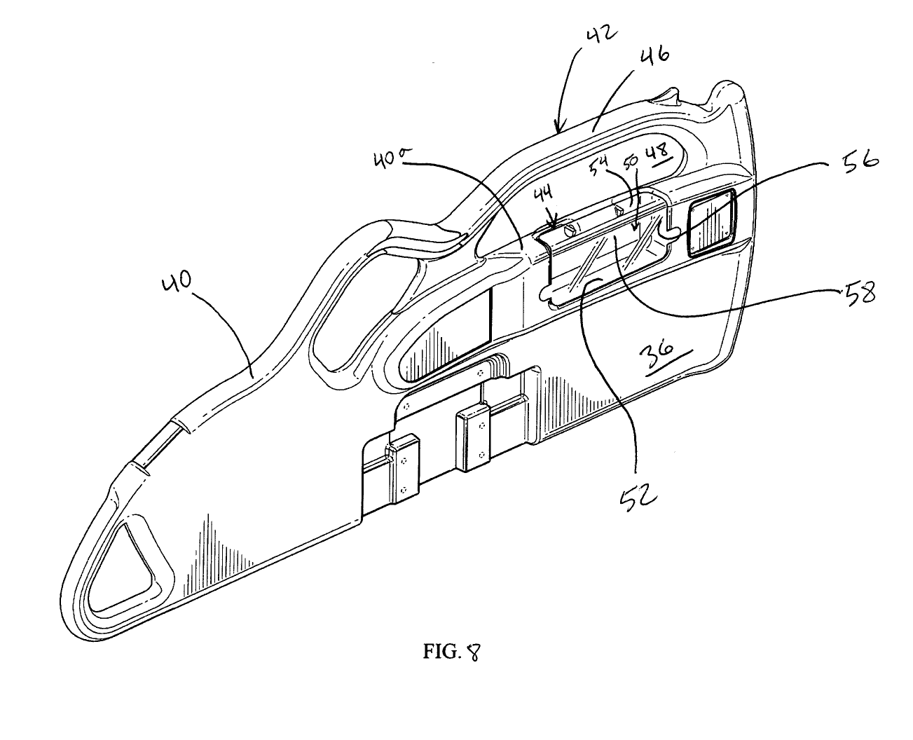

The storage area 50 can be recessed into the siderail body 32 and can include a storage area base 52, a storage area back 54, storage area sides 56, and a retaining element 58 as shown in FIGS. 1-9. It should be appreciated that the at least a portion of the storage area back 54 and the storage area sides 56 can be transparent. In one illustrative embodiment, the storage area back 58 can be recessed into the siderail body 32 between about 0.75 inches and about 1 inch from the first surface 36 of the siderail 24 and can have a width of between about 6.5 inches and about 7 inches and a height of between about 3.5 inches and 4 inches extending from the storage area base 52 to the upper side surface 40a as shown in FIGS. 1-3 & 5-7. In another illustrative embodiment the storage area 50 can be recessed into the siderail body 32 between about 0.75 inches and about 1 inch from the second surface 38 of the siderail 24 and can have a width of between about 6.5 inches and about 7 inches and a height of between about 3.5 inches and 4 inches extending from the storage area base 52 to the upper side surface 40a as shown in FIG. 4. In yet another illustrative embodiment, the storage area 50 can be recessed into the siderail body 32 between the first surface 36 and the second surface 38 such that the storage area sides 56 can be located between the first surface 36 and the second surface 38 and the storage area base 52 can be recessed from the upper side surface 40a between about 3.5 inches and about 4 inches as shown in FIG. 8. It should be appreciated that the height, width, and depth of the storage area 50 can be greater than or less than the previously stated amounts. It should also be appreciated that the storage area 50 can be located on the head siderail 24a and/or the foot siderail 24b as shown in FIGS. 1-8. It should further be appreciated that more than the siderail body 32 can include more than one storage areas 52 thereon.

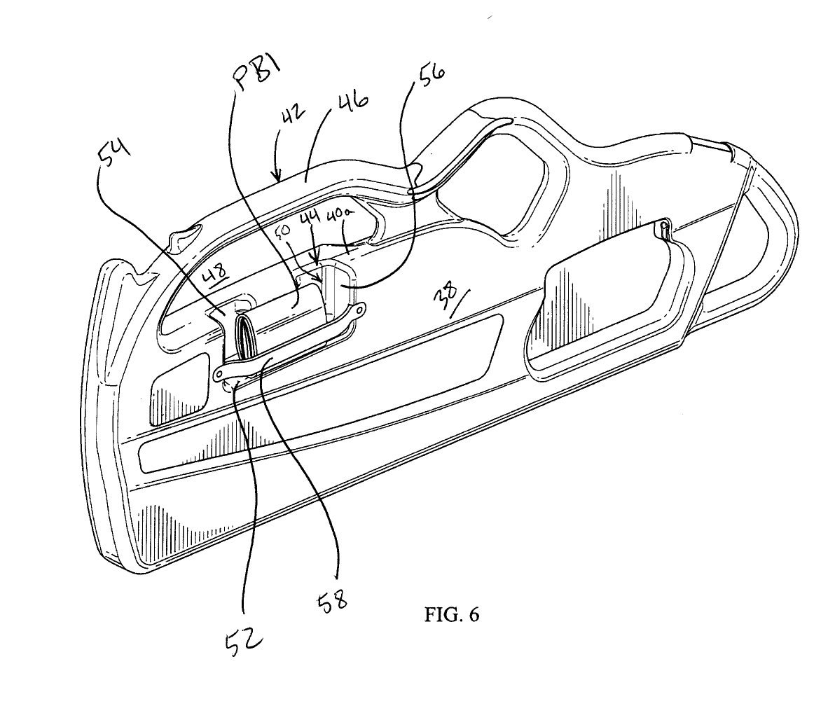

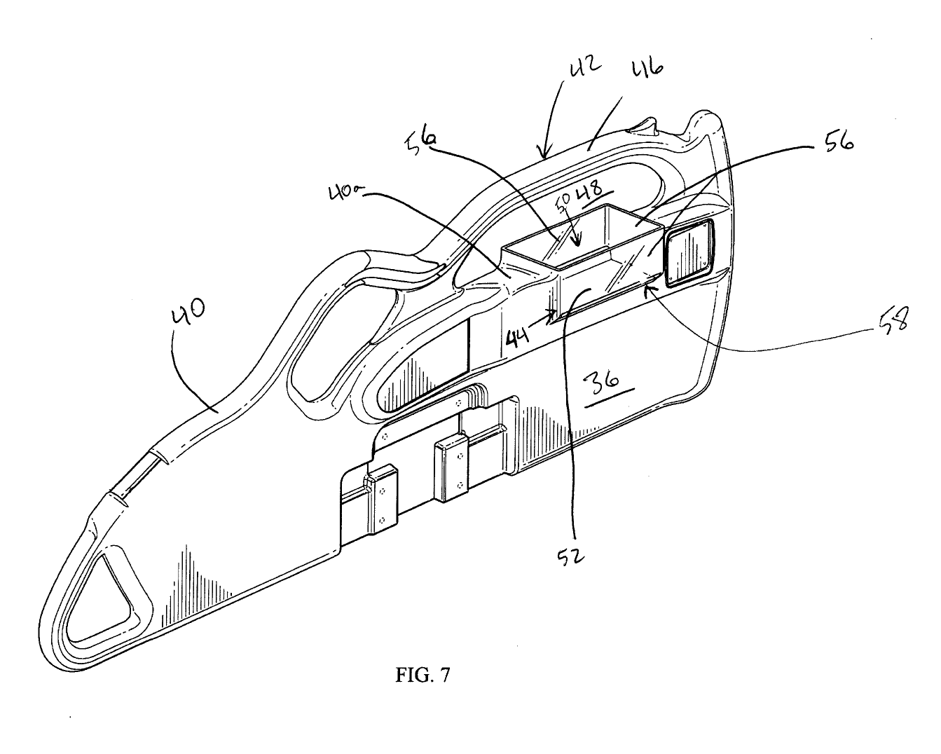

The retaining element 60 can be configured to retain personal belongings PB1 or other objects within the storage area 50 as shown in FIGS. 1-9. In one illustrative embodiment, the retaining element 58 can be or can include at least one of a strap 60a or band 60a, such as, a Velcro strap or an elastic band, as shown in FIGS. 2-5. In another illustrative embodiment, the retaining element 58 can be a plate 60b as shown in FIG. 6. In yet another illustrative embodiment, the retaining element 58 can be a cover 60c as shown in FIG. 7. It should be appreciated that at least a portion of the cover 60c can be transparent. In still another illustrative embodiment, the retaining element 58 can be a protrusion or flange (not shown) that can be integrated into the storage area base 52 and/or the storage area sides 56. In other illustrative embodiments, the retaining element 58 can be a rod (not shown), or other retaining mechanisms.

The retaining element 58 can be configured to extend across the width of the storage area 50 and couple with the first surface 36 of the siderail body 32 when the storage area 50 is located on the first surface 36 and couple with the second surface 38 of the siderail body 32 when the storage area 50 is located on the second surface 38 as shown in FIGS. 1-9. It should be appreciated that the retaining element can be integrated into the siderail body. In one illustrative embodiment, the retaining element 58 can extend across the storage area 50 such that there is a clearance space 62 between the storage area base 52 and the retaining element 58. The clearance space 62 can be configured to provide access to the storage area 50 for cleaning purposes.

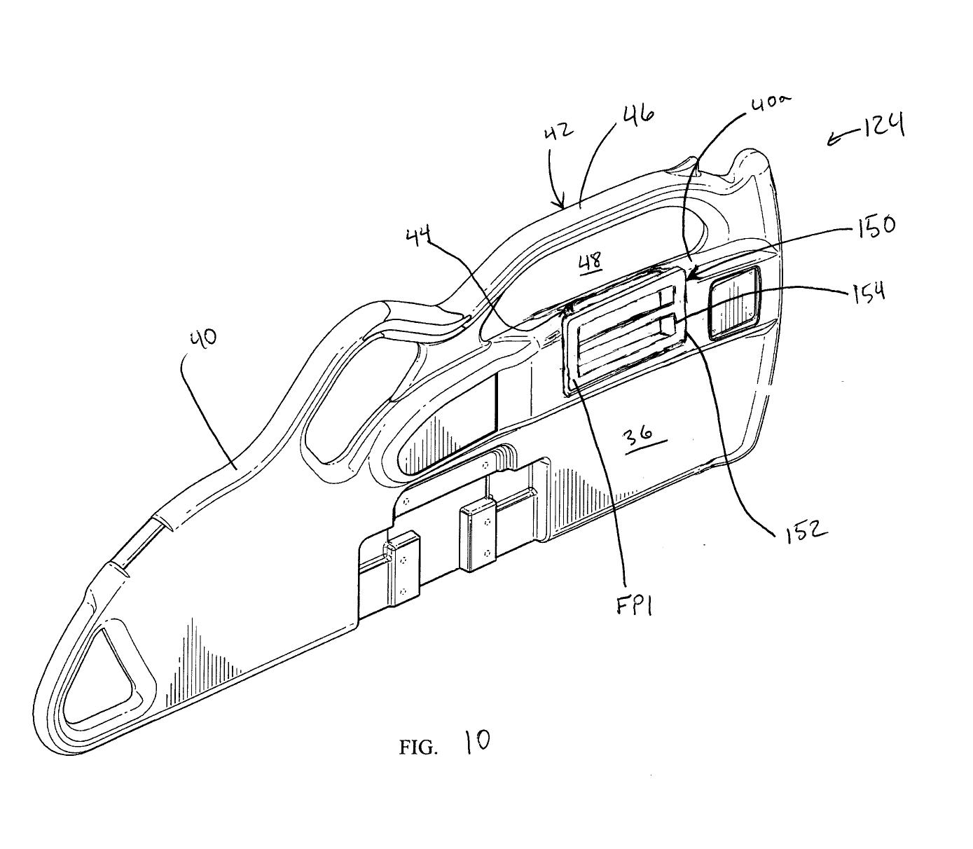

A person-support apparatus 110 according to another illustrative embodiment of the current disclosure is shown in FIG. 10, wherein like reference numbers indicate like features previously described. The person-support apparatus 110 can include a lower frame 12 or base 12, a plurality of supports 14 coupled with the lower frame 12, and an upper frame 116 supported on the supports 14 above the lower frame 12. The upper frame 116 can include an intermediate frame 20, a deck 22, and siderails 124. The siderails 124 can include a siderail body 32 with a top portion ST1 and a bottom portion SB1, a siderail linkage 34, and a removable module 150.

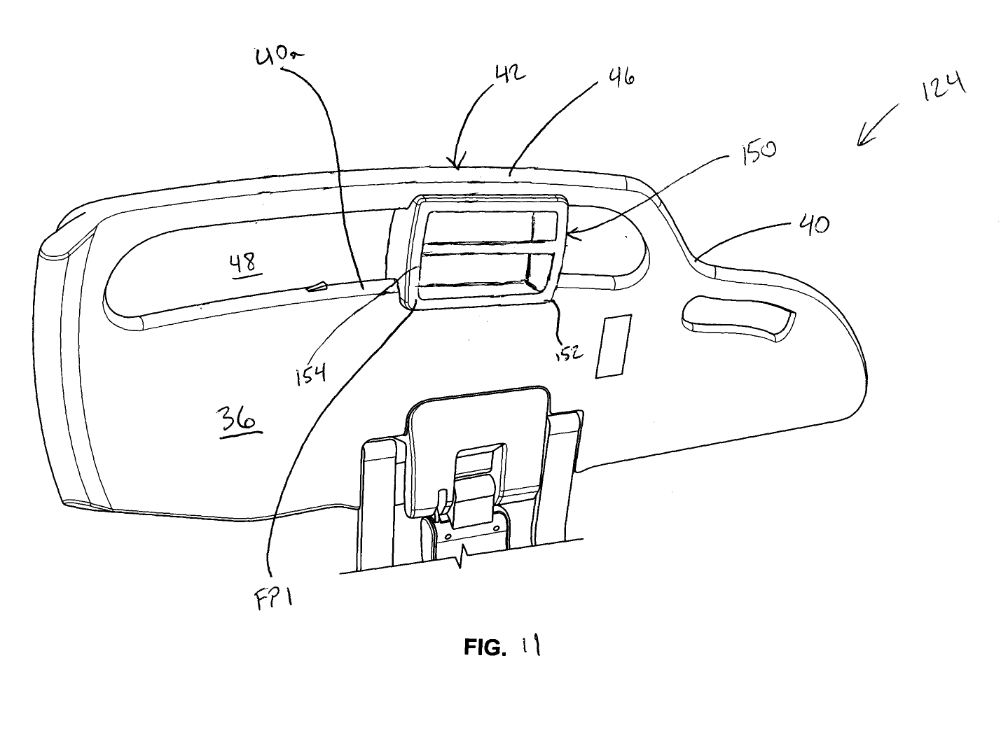

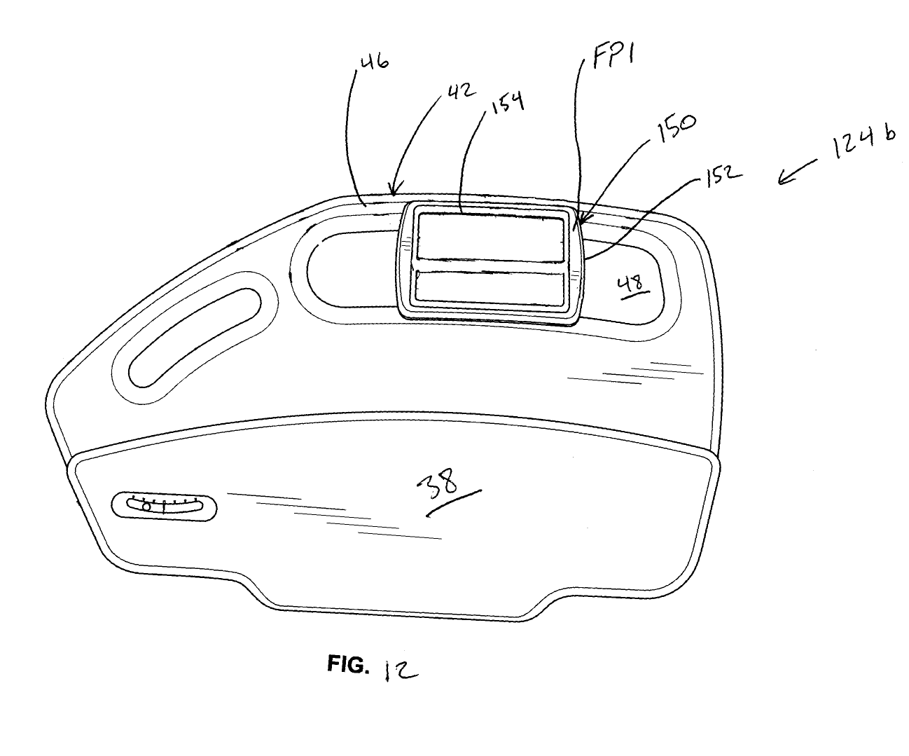

The removable module 150 can be removably coupled to the siderail 124 as shown in FIGS. 10-12. In one illustrative embodiment, at least a portion of the removable module 150 can be received and removably retained within the indented portion 44 of the siderail 124 as shown in FIG. 10. In another illustrative embodiment, the removable module 150 can be configured to be press-fit or snapped into the grip opening 48 as shown in FIG. 11-12. It should be appreciated that the removable module 150 can be removed by pushing or pulling the module 150 in the opposite direction it was press-fit or snapped in. In other embodiments, the removable module 150 can be coupled to the siderail 124 with fasteners (not shown), such as, screws, interlocking members, or other fastening elements. It should be appreciated that the removable module 150 can be generally rectangularly shaped. It should also be appreciated that the removable module 150 can be disposable.

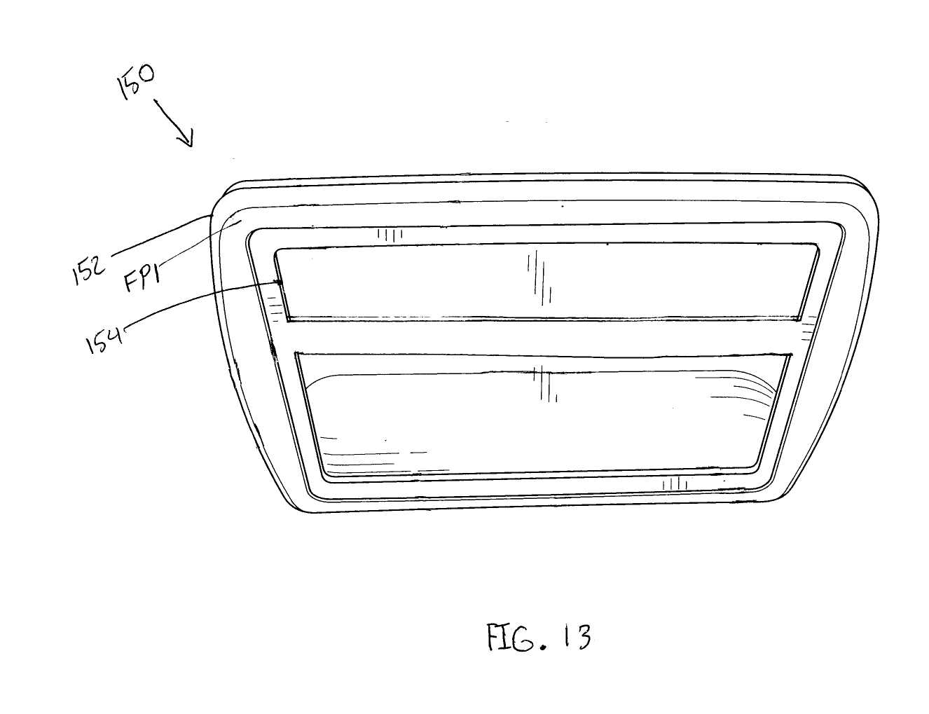

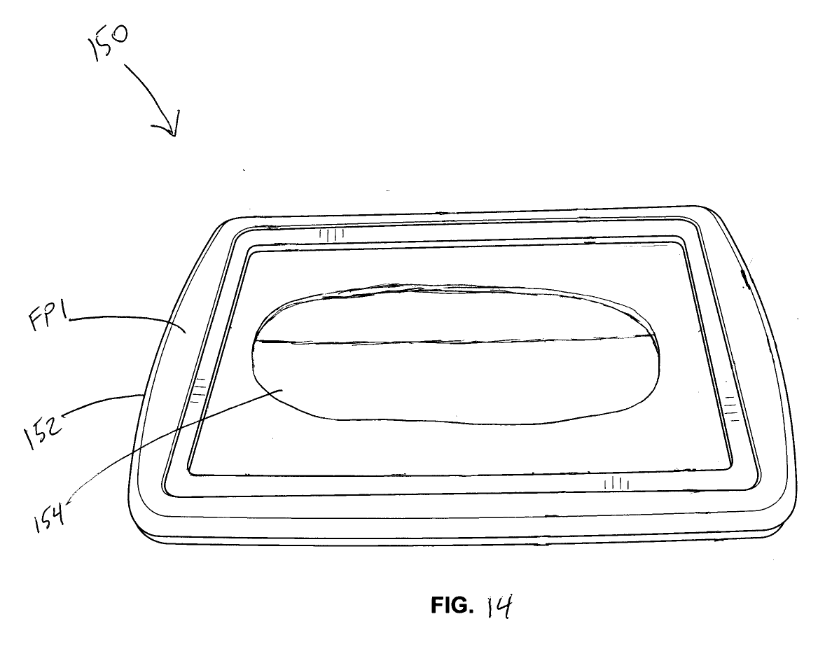

The removable module 150 can be configured to serve different purposes. In one illustrative embodiment, the removable module 150 can be a storage module 150 that can be configured to receive and retain patient belongings, such as, eye glasses, iPods©, cellular phones, etc., or caregiver objects, such as, medical equipment, recording materials, etc. as shown in FIG. 13. In another embodiment, the removable module 150 can be a tissue or antimicrobial wipe dispenser as shown in FIG. 14. In yet another embodiment, the removable module 150 can be an antimicrobial liquid dispenser. It is within the scope of this disclosure to provide a retrofit removable module 150 that can be particularly formed to fit within a particularly-sized opening of a particular siderail 124. In other words, it is within the scope of this disclosure to include removable modules 150 that can be sized and shaped to accommodate the size and shape of any opening of an existing siderail 124. For example, a removable module 150 can be configured to generally follow the shape of the grip 46 and upper side surface 40a. Such a retrofit removable module can also be sized and shaped to provide an interference-fit within the opening of the particular siderail 124 for which they were made.

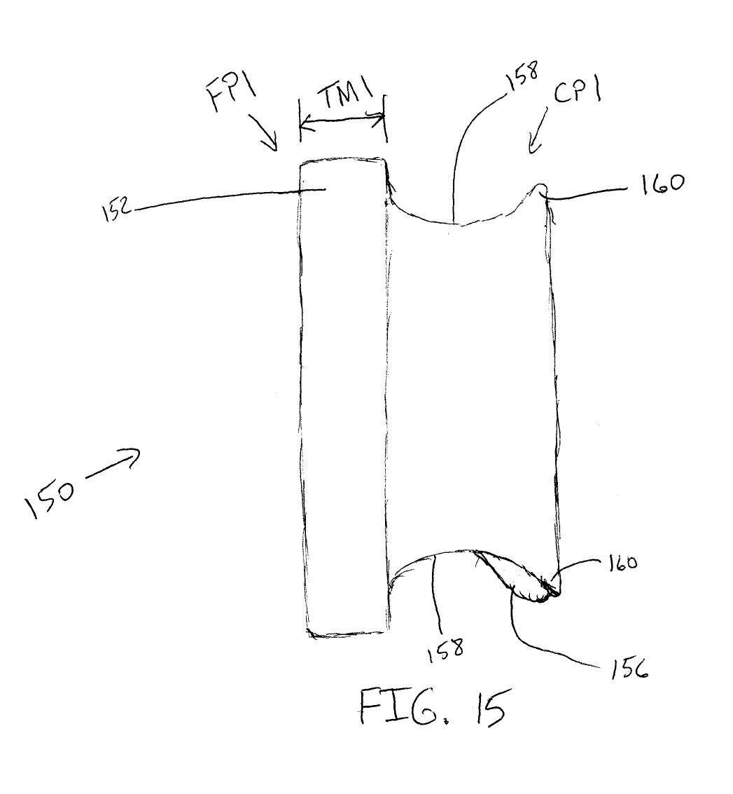

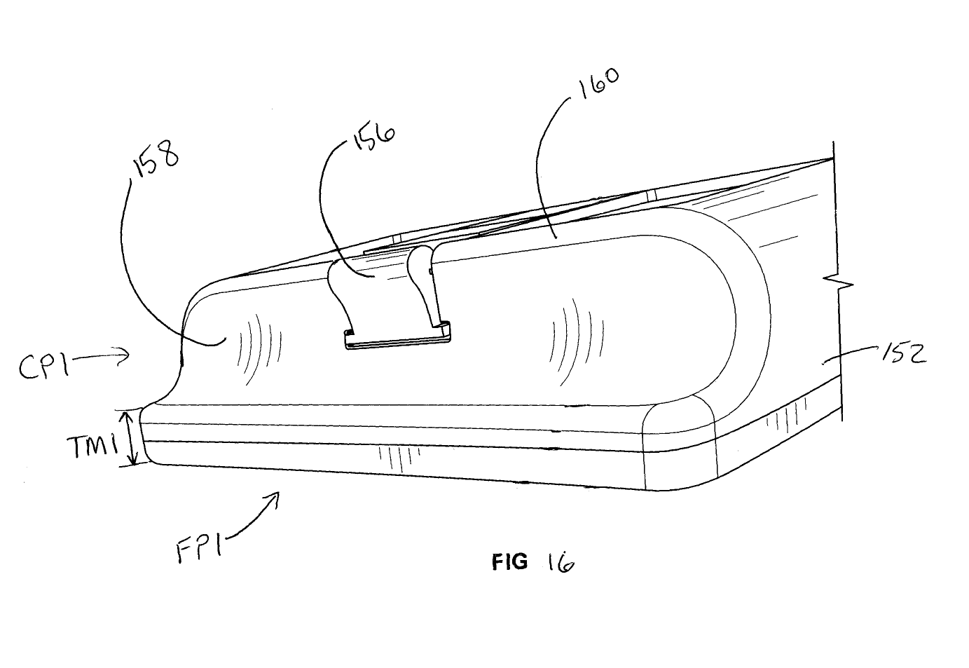

The removable module 150 can include a housing 152 with front portion FP1 and a coupling portion CP1 as shown in FIGS. 15 and 16. The housing 152 can be formed of a polymeric material. The front portion FP1 can include an opening 154 into a storage area for personal belongings or fabric that can be dispensed from the removable module 150. The front portion FP1 can be configured to have a thickness TM1 of about 0.5 inches as shown in FIG. 15. It should be appreciated that at least a portion of the front portion FP1 can be removable.

The coupling portion CP1 can include a retainer 156 and engagement surfaces 158 as shown in FIGS. 15 and 16. The coupling portion CP1 can have a thickness equal to about the thickness of the grip 46. It should be appreciated that the coupling portion CP1 can extend beyond one of the first surface 36 and the second surface 38 about 0.5 inches. The retainer 156 can be a spring actuated mechanism that can be pivotably coupled to the housing 152 and movable relative to the housing 152 between extended and depressed or compressed positions. It should be appreciated that the retainer 156 can be a latch, a friction lock, a screw, suction or vacuum retainer, or other retaining element that can be configured to couple and release the removable module 150 from the siderail 124. In one illustrative embodiment, the retainer 156 can engage at least a portion of the indented portion 44 to maintain at least a portion of the removable module 150 within the indented portion 44. In another illustrative embodiment, the retainer 156 can operate to couple the removable module 150 within the grip opening 48 of the siderail 124 by providing an interference fit between the removable module 150 and the grip 46 and upper side surface 40a. In particular, the retainer 156 can be moved to the compressed position to allow the removable module 150 to be positioned by a user within the grip opening 48 of the siderail 124. Once released, the retainer 156 can be biased toward the extended position to provide an outward force on one of the grip 46 and the upper side surface 40a to maintain the removable module within the grip opening 48.

The engagement surface 158 can be shaped to conform to the contour of the grip 46 and/or the upper side surface 40a as shown in FIGS. 15 and 16. In one illustrative embodiment, at least a portion of the engagement surface 158 is curved to engage a portion of the grip 46. In another illustrative embodiment, at least a portion of the engagement surface 158 is shaped to conform to the contour of the indented portion 44. It should be appreciated that a portion of the engagement surface 158 can form a flange 160 that can be configured to assist in maintaining the removable module 150 within the grip opening 48. The engagement surface can have a thickness equal to the thickness of the grip 46. It should be appreciated that the engagement surface

Many other embodiments of the present disclosure are also envisioned. For example, a person-support apparatus can include a frame and a siderail. The frame is configured to support a person thereon. The siderail is coupled to the frame. The siderail includes a first surface and a second surface. The first surface is oriented such that the first surface faces towards a person supported on the person-support apparatus and the second surface is oriented such that the second surface faces away from the person supported on the person-support apparatus. At least one of the first surface and the second surface has a recessed portion that defines a storage area configured to receive and removably retain one or more objects therewithin.

In another example a person-support apparatus can include a frame and a siderail. The frame is configured to support a person thereon. The siderail is coupled to the frame. The siderail includes a first surface and a second surface. The first surface is oriented such that the first surface faces towards a person supported on the frame and the second surface is oriented such that the second surface faces away from the person supported on the frame. At least one of the first surface and the second surface includes a recessed portion that defines a storage area for a person supported on the frame to place one or more objects within.

In yet another example a person-support apparatus can include a frame and a siderail. The frame is configured to support a person thereon. The siderail is coupled to the frame. The siderail includes a first surface and a second surface. The first surface is oriented such that the first surface faces towards a person supported on the frame and the second surface is oriented such that the second surface faces away from the person supported on the frame. At least one of the first surface and the second surface includes a recessed portion that defines a storage area to place one or more objects within. The storage area includes a retaining element for holding the one or more objects in a stable position. The retaining element is a member that extends across the recessed portion.

In still another example a person-support apparatus can include a frame, a siderail, and a removable module. The frame is configured to support a person thereon. The siderail is coupled to the frame. The siderail includes a first surface and a second surface. The first surface is oriented such that the first surface faces towards a person supported on the person-support apparatus and the second surface is oriented such that the second surface faces away from the person supported on the person-support apparatus. At least one of the first surface and the second surface has an indented portion. The removable module defines a storage area configured to be received in the indented portion and configured to at least one of dispense a fabric and removably retain one or more objects therewithin.

In still another example a siderail assembly for a person-support apparatus comprises a frame, a siderail, and a removable module. The frame is configured to support a person thereon. The siderail is coupled to the frame. The siderail includes a siderail body and a grip portion. The grip portion includes a grip and an opening between the grip and the siderail body. The removable module is configured to removably couple with the siderail between the grip portion and the siderail body and is configured to at least one of store objects therein and dispense a fabric

In still another example a person-support apparatus comprises a frame, a siderail, and a removable module. The frame is configured to support a person thereon. The siderail is coupled to the frame. The removable module is configured to couple to the siderail and to at least one of dispense a fabric and removably retain one or more objects therewithin. The overall thickness of the siderail when the removable module is coupled to the siderail is less than about three inches.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

1-23. (canceled)

24. A siderail assembly for a person-support apparatus, comprising:
a frame configured to support a person thereon;
a siderail coupled to the frame, the siderail including a first surface and a second surface, the first surface and the second surface being generally parallel to one another, the first surface being oriented such that the first surface faces towards a person supported on the frame and the second surface being oriented such that the second surface faces away from the person supported on the frame, the first surface and the second surface oriented to receive a removable recessed portion defining a storage area for a person supported on the frame to place one or more objects within.

25-26. (canceled)

27. A person-support apparatus, comprising:
a frame configured to support a person thereon;
a siderail coupled to the frame; and
a removable module configured to couple to the siderail and to at least one of dispense a fabric and removably retain one or more objects therewithin, wherein the overall thickness of the siderail when the removable module is coupled to the siderail is less than about three inches.

28. The person-support apparatus of claim 27, wherein the removable module includes a coupling portion with a retainer and an engagement surface, wherein the retainer and the engagement surface cooperate with a portion of the siderail to couple the removable module to the siderail.

29. The person-support apparatus of claim 28, wherein the retainer provides an interference fit to couple the removable module to the siderail.

30. The person-support apparatus of claim 28, wherein a portion of the engagement surface is shaped to conform to the contour of a portion of a grip on the siderail.

31. The person-support apparatus of claim 30, wherein the engagement surface is curved.

32. The person-support apparatus of claim 27, wherein the removable module is configured to store at least one of personal belongings and caregiver objects therein.

33. The person-support apparatus of claim 27, wherein the removable module is configured to dispense fabric.

34. The person-support apparatus of claim 33, wherein the fabric is an antimicrobial wipe.

35. The person-support apparatus of claim 28, wherein the removable module is configured to removably couple with an indented portion of the siderail.

36. The person-support apparatus of claim 28, wherein the removable module is configured to be inserted into an opening in the siderail and frictionally engage a portion of the siderail surrounding the opening to removably retain the removable module within the siderail.

37. A method of retrofitting a siderail with a removable storage module, comprising:
coupling the removable storage module to the siderail;
modifying the width of the siderail with the removable storage module such that the overall width of the siderail with the removable storage coupled thereto is less than about three inches.

38. The method of claim 37, wherein the siderail is between about 1.5 inches and about 2 inches thick and the removable storage module is between about 1 inch and 0.5 inches.

39. The method of claim 38, wherein the siderail is about 2 inches thick and includes a first surface and a second surface, the storage module extends beyond at least one of the first surface and the second surface of the siderail about 0.5 inches.
